(19) United States
(12) Patent Application Publication
(10) Pub. No.: US 2025/0362852 A1
(43) Pub. Date: Nov. 27, 2025

(54) JOB EXECUTION SYSTEM, CONTROL METHOD, AND COMPUTER-READABLE NON-TRANSITORY RECORDING MEDIUM

(71) Applicant: Konica Minolta, Inc., Tokyo (JP)

(72) Inventor: Junpei KAMINAKA, Tokyo (JP)

(21) Appl. No.: 19/203,713

(22) Filed: May 9, 2025

(30) Foreign Application Priority Data
May 24, 2024 (JP) 2024-084673

(51) Int. Cl. G06F 3/12

(52) U.S. Cl. CPC G06F 3/1262; G06F 3/1219; G06F 3/1286

(57) ABSTRACT

A job execution system comprises a controller and a job execution apparatus. The controller combines a plurality of jobs to generate a combined job, and transmits job information on at least one of the plurality of jobs and the combined job. The job execution apparatus acquires and manages the job information and the combined job, and executes the combined job.

### CROSS REFERENCE TO RELATED APPLICATIONS

The present application is based on Japanese Patent Application No. 2024-084673 filed on May 24, 2024, the contents of which are incorporated herein by reference.

### BACKGROUND OF THE INVENTION

### Technical Field

The present invention relates to a job execution system, a control method, and a computer-readable non-transitory recording medium.

### Description of Related Art

Conventionally, image forming systems that form images on continuous printing medium such as roll sheet are known (e.g., Japanese Unexamined Patent Publication No. JP2017-40711A). This image forming system includes an image forming apparatus (apparatus main body) and a controller. The controller is capable of communicating with an external device via a network. When receiving data to be printed from the external device, the controller generates a job and outputs the job to the image forming apparatus. The image forming apparatus forms and outputs an image on the continuous print medium on the basis of the job output from the controller. At this time, a blank portion occur before and after a portion of the continuous printing medium on which an image is formed. The blank portion is cut in a later cutting process and becomes waste sheet. Therefore, in order to reduce the blank portion between jobs, a conventional image forming system generates a combined job by combining a plurality of jobs in a controller. Upon receiving the combined job from the controller, the image forming apparatus executes the combined job as one job.

However, in the conventional image forming system, when the combined job is stopped while the combined job is being executed in the image forming apparatus, it is not possible to grasp which job among the plurality of jobs included in the combined job has been completed. For example, in a case where two jobs of the first job and the second job are included in the combined job, if the first job has already been completed at the time of stopping the combined job, it is not necessary to execute the first job at the time of resuming the combined job. However, since the conventional image forming apparatus manages the combined job as one job, it is not possible to recognize whether or not the first job is completed at the time of stopping the combined job.

Therefore, in the conventional image forming system, when the combined job is stopped in the image forming apparatus, only one of the following two methods can be selected: the method of restarting the combined job from the beginning when restarting the combined job; and the method of restarting the combined job from the stopped position. For example, in a case where the combined job is stopped in a state where the first job included in the combined job is already completed, when the combined job is performed again from the beginning at the time of resuming the combined job, the image included in the first job is formed again, which is wasteful. Furthermore, if the job is resumed from the position where the job is stopped when the combined job is resumed, the blank portion is generated also when the job is resumed, so that a blank sheet is mixed in the middle of the job. If the blank sheet is mixed between consecutive pages, the blank portion needs to be cut and removed in a later cutting process. At this time, a sheet feeding amount has to be individually set so that the blank portion is appropriately cut in the cutting process, which causes troublesome work for a user.

### SUMMARY OF THE INVENTION

The present invention has been devised in order to solve the above-described problems. It is an object of the present invention to provide the job execution system, a control method, and a computer-readable non-transitory recording medium, wherein when a combined job in which a plurality of jobs generated in a controller are combined is acquired and executed, individual jobs included in the combined job can be managed.

In order to achieve the above objects, firstly, the present invention is directed to a job execution system.

According to one aspect of the invention, the job execution system comprises a controller and a job execution apparatus. The controller combines a plurality of jobs to generate a combined job, and transmits job information on at least one of the plurality of jobs and the combined job. The job execution apparatus acquires and manages the job information and the combined job, and executes the combined job.

Second, the present invention is directed to a control method for controlling an image forming apparatus.

According to one aspect of the invention, the control method includes: acquiring a combined job in which a plurality of jobs combined and job information relating to at least one of the plurality of jobs; forming an image based on the combined job; updating the job information in accordance with progress of the combined job; and outputting the job information.

Third, the present invention is directed to a non-transitory computer-readable recording medium storing a program to be executed by a hardware processor of an image forming apparatus.

According to one aspect of the invention, the program causes the hardware processor to perform: acquiring a combined job in which a plurality of jobs combined and job information relating to at least one of the plurality of jobs; forming an image based on the combined job; updating the job information in accordance with progress of the combined job; and outputting the job information.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a conceptual diagram illustrating an overall configuration of the job execution system;

FIG. 2 is a block diagram illustrating a control mechanism of the job execution system;

FIG. 3 is a diagram illustrating a concept of combining a plurality of jobs;

FIG. 4A and FIG. 4B are diagrams showing a comparison between a case where images are formed on continuous printing medium based on a normal job and a case where images are formed on continuous printing medium based on a combined job;

FIG. 5A and FIG. 5B are diagrams illustrating information generated by the combining section;

FIG. 6 is a diagram showing information sent from the controller to the job execution apparatus;

FIG. 7A and FIG. 7B are diagrams illustrating screens to be displayed on the operation panel;

FIG. 8A and FIG. 8B are diagrams illustrating screens to be displayed on the operation panel;

FIG. 9 is a flowchart illustrating an example of a processing procedure by a controller;

FIG. 10 is a flowchart illustrating an example of a processing procedure by the job execution apparatus; and

FIG. 11 is a flowchart illustrating an example of a detailed processing procedure of updating job information.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### Preferred Embodiment of the Invention

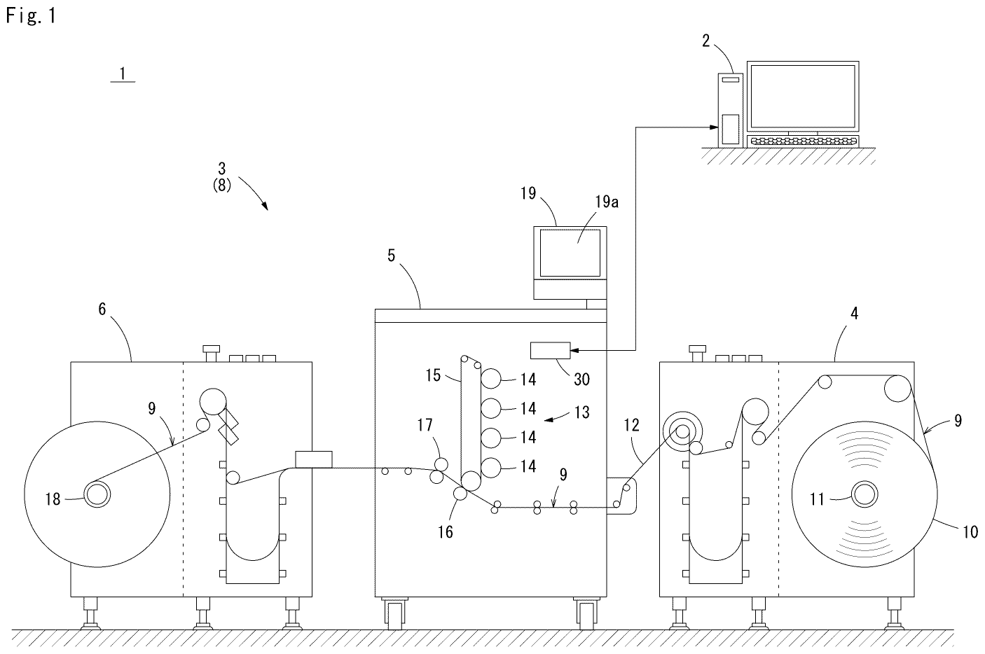

FIG. 1 is a conceptual diagram illustrating an overall configuration of the job execution system 1 according to an embodiment of the present invention. The job execution system 1 includes the controller 2 and the job execution apparatus 3. The controller 2 and the job execution apparatus 3 can communicate with each other. The job execution apparatus 3 of the present embodiment is constituted by the image forming apparatus 8. Hereinafter, the job execution apparatus 3 will be described as the image forming apparatus 8.

The controller 2 outputs a job to the image forming apparatus 8, and causes the image forming apparatus 8 to perform a printing operation. For example, the controller 2 includes a personal computer (PC), a server, or the like. The controller 2 is connected to a network such as a local area network (LAN). Upon receiving image data to be printed from another external device via the network, the controller 2 generates a job executable by the image forming apparatus 8. Further, the controller 2 may receive a job generated by an external device.

The image forming apparatus 8 continuously conveys a long continuous printing medium 9 such as roll sheet, forms an image on the continuous printing medium 9, and outputs the continuous printing medium 9. The image forming apparatus 8 includes a sheet feed unit 4, an image forming unit 5, and a sheet ejection unit 6. A conveyance path 12 for conveying the continuous printing medium 9 is formed in the sheet feed unit 4, the image forming unit 5, and the sheet ejection unit 6.

The sheet feed unit 4 holds roll sheet 10 in which the continuous printing medium 9 is wound around a shaft core 11, and feeds the continuous printing medium 9 from the roll sheet 10 to the conveyance path 12. The sheet feed unit 4 then feeds the continuous printing medium 9 to the image forming unit 5. The sheet feed unit 4 has a buffer function to absorb a minute speed difference between a conveyance speed of the continuous printing medium 9 delivered from the roll sheet 10 and a conveyance speed of the continuous printing medium 9 in the image forming unit 5. The buffer function also has a function of applying an appropriate tension to the continuous printing medium 9.

The image forming unit 5 includes an image forming section 13 that forms an image on the continuous printing medium 9. In addition, the image forming unit 5 includes an operation panel 19 serving as a user interface on an upper portion of the unit. The operation panel 19 includes a display part 19a that displays various kinds of information. The display part 19a is configured as a touch screen. Therefore, the operation panel 19 can receive a user's operation on the display part 19a.

A image forming section 13 includes a plurality of photoreceptors 14, an intermediate transfer belt 15, a secondary transfer roller 16, and a fixing section 17.

The plurality of photoreceptors 14 correspond to a plurality of colors such as cyan, magenta, yellow, and black, respectively, and are arranged at predetermined intervals along the longitudinal direction of the intermediate transfer belt 15. A charging device, an exposure device, and a developing device are disposed around each of the photoreceptors 14. The surface of the photoreceptor charged by the charging device is exposed by the exposure device. Thus, an electrostatic latent image is formed on the surface of the photoreceptor. The developing device develops the electrostatic latent image with a developer containing toner. Thus, a toner image is formed on the surface of the photoreceptor 14.

The intermediate transfer belt 15 is an endless belt that circularly moves in a predetermined direction in contact with the photoreceptor 14 of each color. The toner images formed on the surfaces of the photoreceptor 14 are sequentially first transferred to the intermediate transfer belt 15 that circulates. The toner images of the respective colors are primarily transferred to the same position of the intermediate transfer belt 15 so as to overlap each other, whereby a color image is formed on the intermediate transfer belt 15. The color image formed on the intermediate transfer belt 15 is secondarily transferred, by the secondary transfer roller 16, onto the continuous printing medium 9 conveyed along the conveyance path 12.

The fixing section 17 is provided on a downstream side of the secondary transfer roller 16 in the conveyance path 12. The fixing section 17 applies heat treatment and pressure treatment to the continuous printing medium 9 on which the image has been transferred, to fix the image on the continuous printing medium 9. The image fixed by the fixing section 17 is conveyed to the sheet ejection unit 6 with the conveyance of the continuous printing medium 9.

The sheet ejection unit 6 collects the continuous printing medium 9 on which an image has been formed by the image forming unit 5, by winding the continuous printing medium 9 around a core 18. The sheet ejection unit 6 has a buffer function to absorb a minute speed difference between a conveyance speed of the continuous printing medium 9 in the image forming unit 5 and a winding speed around the core 18. The buffer function also has a function of applying an appropriate tension to the continuous printing medium 9. Therefore, the continuous printing medium 9 is wound around the core 18 without causing a shift or the like.

The continuous printing medium 9 wound around the core 18 is cut in a later cutting process and processed into a specified printed product.

The image forming apparatus 8 includes a controller 30 that controls the above-described image forming operation. Upon receiving a job from the controller 2, the controller 30 registers the job as a reserved job. At the timing when the next job can be executed, the controller 30 reads a job to be executed next from among the jobs registered as reserved jobs, and executes the read job. For example, when the last image formed in the preceding job is wound up around the core 18 by the sheet ejection unit 6, the controller 30 determines that the next job can be executed. Then, the controller 30 reads out the next job from the reserved jobs and executes the job.

In the job execution system 1 as described above, a plurality of image forming apparatuses 8 may be connected to the controller 2. In this case, the controller 2 outputs a job to each of the plurality of image forming apparatuses 8. For example, the controller 2 manages reserved jobs accumulated in each of the plurality of image forming apparatuses 8, selects one image forming apparatus 8 based on the accumulation state of the reserved jobs, and outputs the job.

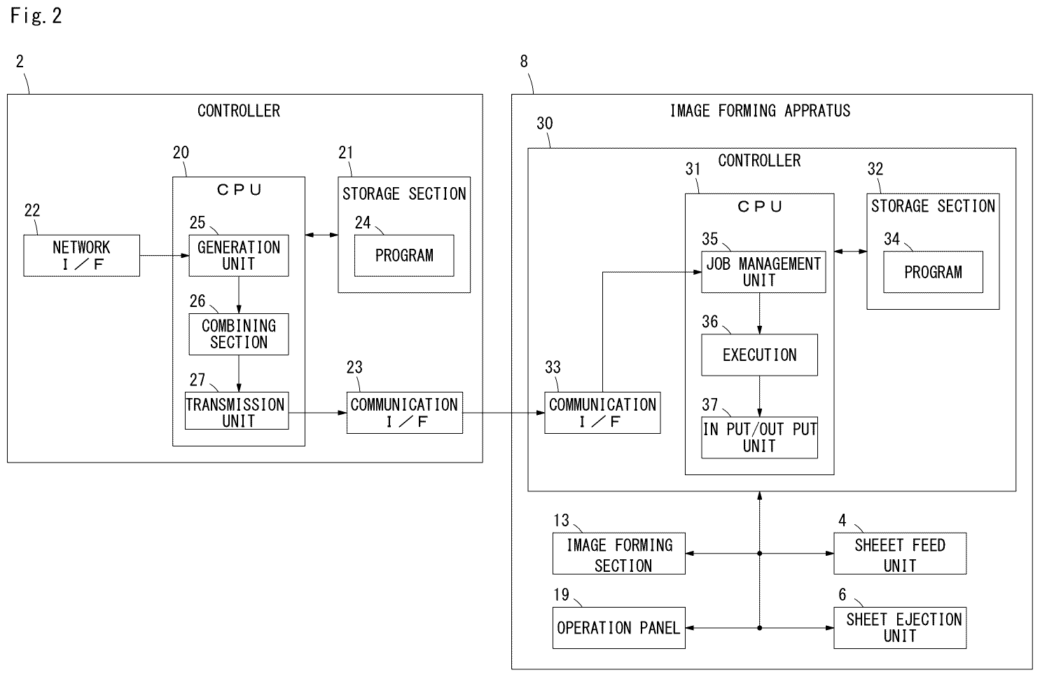

FIG. 2 is a block diagram illustrating a control mechanism of the job execution system 1. The hardware configuration of the controller 2 includes a CPU 20, a storage section 21, a network interface 22, and a communication interface 23. The CPU 20 is a hardware processor that executes a computer-readable program. The storage section 21 is a nonvolatile storage device, for example, a hard disk drive (HDD) or a solid state drive (SSD). The storage section 21 stores in advance a program 24 to be executed by the CPU 20. The network interface 22 is an interface for connecting the controller 2 to a network and communicating with an external device. The communication interface 23 is an interface for connecting the controller 2 to the image forming apparatus 8 and communicating with the image forming apparatus 8. The communication interface 23 may also serve as the network interface 22.

CPU 20 Functions as a generation unit 25, a combining section 26, and a transmission unit 27 by executing the program 24.

Upon receiving image data to be printed via the network interface 22, the generation unit 25 generates a job executable in the image forming apparatus 8. Further, the generation unit 25 may access an external device via the network interface 22 based on a user instruction, read image data from the external device, and generate a job. The job generated by the generation unit 25 is temporarily stored in the storage section 21. Furthermore, when the generation unit 25 receives a job from the external device, the generation unit 25 temporarily stores the received job in the storage section 21.

When a plurality of jobs is stored in the storage section 21, the combining section 26 combines the plurality of jobs to generate one combined job. For example, the combining section 26 reads a plurality of jobs to be combined from the storage section 21 based on a user's instruction, and combines the plurality of jobs to generate a combined job.

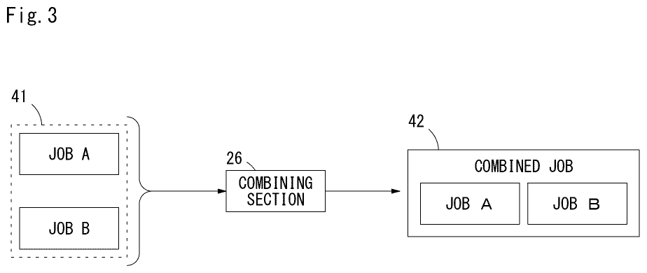

FIG. 3 is a diagram illustrating a concept of combining a plurality of jobs. As illustrated in FIG. 3, when two jobs 41 of a job A and a job B are to be combined, the combining section 26 generates a combined job 42 by combining the two jobs A and B. The combined job 42 includes an image of the job A and an image of the job B. That is, the combined job 42 is a job for continuously forming the images included in the two jobs A and B on the continuous printing medium 9.

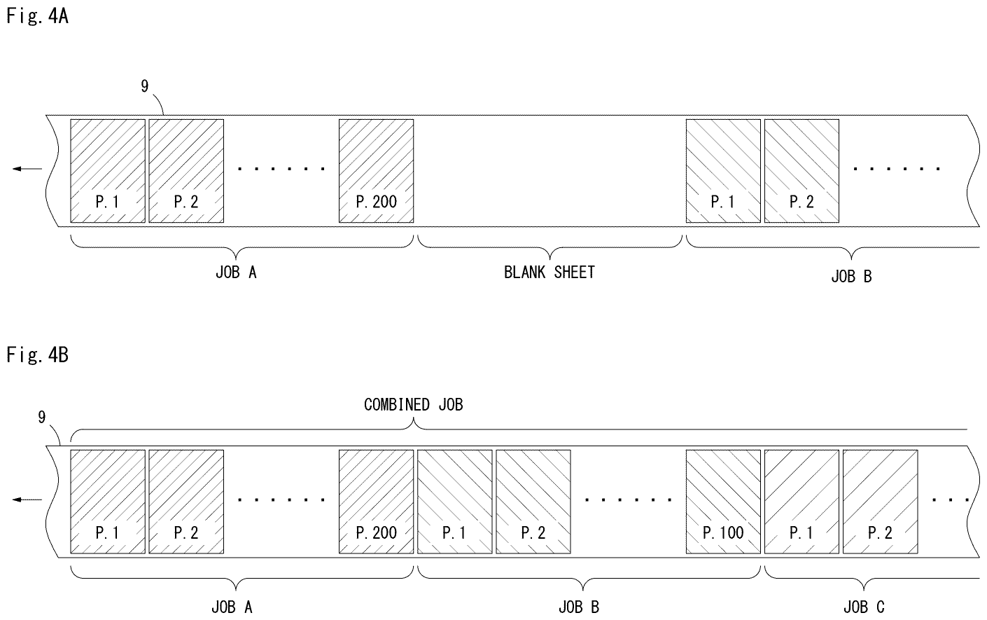

FIG. 4A and FIG. 4B are diagrams showing a comparison between a case where an image is formed on the continuous printing medium 9 based on a normal job (single job) and a case where an image is formed on the continuous printing medium 9 based on a combined job. For example, when the image forming apparatus 8 executes as a normal job without combining the plurality of jobs A and B, as illustrated in FIG. 4A, a blank portion occurs between the image of the job A and the image of the job B on the continuous printing medium 9.

On the other hand, when the combining section 26 combines the plurality of jobs A, B, and C to generate a combined job, and the image forming apparatus 8 executes the combined job, it is possible to eliminate the blank sheet between the image of the job A and the image of the job B on the continuous printing medium 9 as illustrated in FIG. 4B. Furthermore, the same applies to between the job B and the job C. Provided that when generating the combined job 42, the combining section 26 may provide a blank portion between the job A and the job B. For example, when it is set in advance by the user that a blank sheet of a predetermined length corresponding to one page or several pages is provided between the plurality of jobs 41, the combining section 26 generates the combined job 42 by providing a blank portion designated in advance between the job A and the job B. The length of the blank portion in this case is preferably made shorter than the length of the blank portion generated when the jobs A and B are executed as the normal jobs. As described above, the combining section 26 combines the plurality of jobs 41 to generate the combined job 42, thereby reducing blank sheets generated on the continuous printing medium 9.

When generating the combined job 42, the combining section 26 generates combined job information related to the combined job 42 and job information related to at least one job of the plurality of jobs 41 included in the combined job 42.

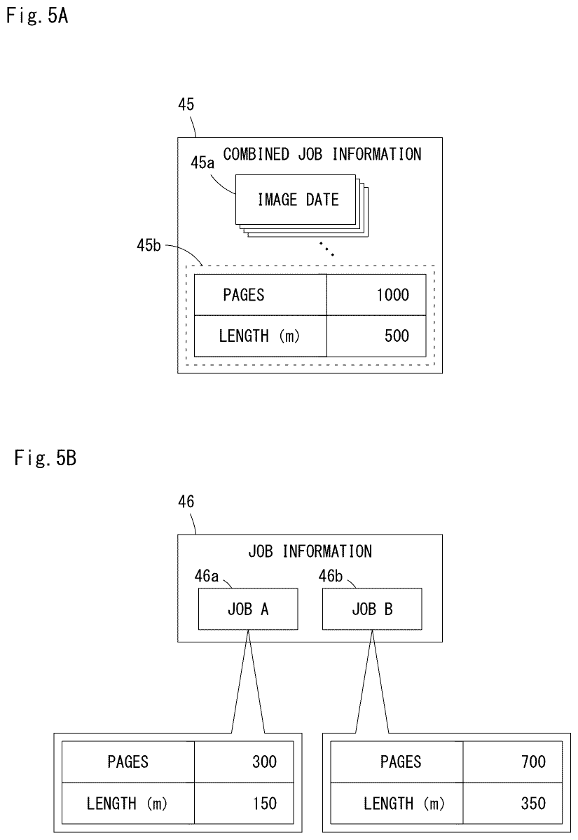

FIG. 5A and FIG. 5B are diagrams illustrating information generated by the combining section 26. FIG. 5A illustrates combined job information 45. The combined job information 45 is information used for execution of the combined job 42 and represents the combined job 42 itself. The combined job information 45 includes image data 45a to be formed on the continuous printing medium 9 in the image forming apparatus 8. The image date 45a included in the combined job information 45 is an image date included in each of the plurality of combined jobs 41. The combined job information 45 also includes additional information 45b related to the combined job 42. The attached information 45b is information for managing the combined job 42, and includes, for example, information on the number of pages of the image date 45a and the lengths (distances) of the continuous printing medium 9 required for printing all the image date 45a. In the example of FIG. 5A, the combined job information 45 includes additional information 45b indicating that there are 1000 pages of image data 45a and 500 m lengths (distances) required for printing. Note that details of the plurality of jobs 41 included in the combined job 42 are unknown in the information included in the combined job information 45.

FIG. 5B illustrates the job information 46 generated together with the combined job information 45. The job information 46 includes information on at least one job among the plurality of jobs 41 included in the combined job 42. The job information 46 may include information on all the jobs 41 included in the combined job 42. For example, when the combined job 42 in which the two jobs A and B are combined is generated, the job information 46 shown in FIG. 5B includes information 46a and 46b about the two jobs A and B. The information 46a about job A includes information about the number of pages of image data included in job A and the length (distance) of the continuous printing medium 9 required for printing job A. The information 46b on job B includes the number of pages of image data included in job B and the length (distance) of the continuous printing medium 9 required to print job B. Therefore, by referring to the job information 46, the details of the plurality of jobs 41 included in the combined job 42 are known.

Note that in a case where the two jobs A and B are included in the combined job 42, if there is the information 46a regarding one job A, the information 46b regarding the other job B can be estimated from an attached information 45b of the combined job information 45 and the information 46a regarding the job A. Therefore, the combining section 26 may generate the job information 46 including only the information 46a about the job A. Further, the combining section 26 may generate the job information 46 including only the information 46b about the job B.

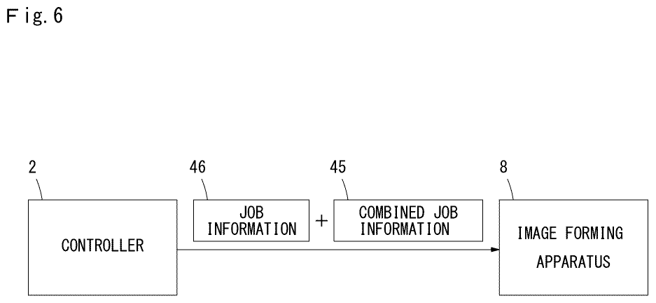

Referring back to FIG. 2, the transmission unit 27 transmits the job to the controller 30 of the image forming apparatus 8 via the communication interface 23. When the combined job 42 is generated by the combining section 26, the transmission unit 27 transmits the combined job 42 to the controller 30. At this time, as illustrated in FIG. 6, the transmission unit 27 transmits the combined job information 45 and the job information 46 in association with each other to the controller 30. Note that when it is specified by the user to transmit a normal job instead of the combined job, the transmission unit 27 reads the specified job from the storage section 21 and transmits it to the controller 30.

The controller 30 of the image forming apparatus 8 includes, as its hardware configuration, a CPU 31, a storage section 32, and a communication interface 33. The CPU 31 is a hardware processor that executes a computer-readable program. The storage section 32 is a nonvolatile storage device, for example, a hard disk drive (HDD) or a solid state drive (SSD). A program 34 to be executed by the CPU 31 is stored in the storage section 32 in advance. The communication interface 33 is an interface for communicating with the controller 2. The communication interface 33 may be capable of communicating with an external device other than the controller 2.

The CPU 31 functions as a job management unit 35, an execution unit 36, and an input/output unit 37 by reading and executing the program 34 from the storage section 32.

The job management unit 35 manages a job executed in the image forming apparatus 8. The job management unit 35 receives and acquires a job transmitted from the controller 2 via the communication interface 33. When a job is acquired, the job management unit 35 temporarily stores the job in the storage section 32 and registers the job as a reserved job. A job management unit 35 manages the execution order of reserved jobs and instructs an execution unit 36 to execute the reserved jobs. Furthermore, as the job is executed by the execution unit 36, the job management unit 35 manages the progress status of the job.

When the combined job 42 is generated in the controller 2, the job management unit 35 receives the combined job information 45 and the job information 46. In this case, the job management unit 35 manages the combined job 42 on the basis of the combined job information 45 and the job information 46. For example, when the combined job 42 is reserved and registered, the job management unit 35 registers the combined job 42 as a reserved job based on the combined job information 45, and registers the plurality of jobs A and B included in the combined job 42 based on the job information 46. For example, based on the job information 46, the job management unit 35 registers information such as the number of pages and the length of the plurality of jobs A and B included in the combined job 42 in the detailed information of the combined job 42 registered as the reserved job. Then, the job management unit 35 manages the combined job 42 registered as the reserved job. Acquiring information such as the number of pages and the length of the plurality of jobs A and B included in the combined job 42 also corresponds to the management by the job management unit 35.

For example, when the number of pages described in the attached information 45b of the combined job information 45 and the total number of pages of each job included in the job information 46 do not match, the job information 46 does not include information on all the jobs combined as the combined job 42. That is, in the job information 46, information of a part of the plurality of jobs 41 combined into the combined job 42 is missing. In this case, the job management unit 35 estimates the information on the job not included in the job information 46 from the information included in the combined job information 45 and the job information 46. Next, the job management unit 35 manages the estimated information as information on the job included in the combined job 42.

The execution unit 36 controls execution of a job in the image forming apparatus 8. Based on an instruction from the job management unit 35, the execution unit 36 reads a job registered as a reserved job in the storage section 32, and executes the job by operating each of the sheet feed unit 4, the image forming section 13, and the sheet ejection unit 6.

In the case of the combined job 42, the execution unit 36 reads the combined job information 45, and controls the execution of the job based on the combined job information 45. That is, the execution unit 36 causes the image forming section 13 to perform an image forming operation based on the image date 45a included in the combined job information 45. Thus, the images included in the combined job 42 are continuously formed on the continuous printing medium 9. By executing the combined job 42, the execution unit 36 can reduce blank sheets generated between the plurality of jobs A and B included in the combined job 42.

When the combined job 42 is being executed, the execution unit 36 stops the execution of the combined job 42 upon detection of an abnormal state such as occurrence of a jam or toner empty. Next, the execution unit 36 notifies the user that an abnormal state has been detected. When the execution of the combined job 42 is stopped in the middle, the user specifies the cause of the occurrence of the abnormal state and performs an operation of resolving the abnormal state. When the abnormal state is resolved, the user instructs the image forming apparatus 8 to resume the combined job 42.

The restart instruction is accepted by the job management unit 35. Upon receiving a restart instruction from the user, the job management unit 35 instructs the execution unit 36 to restart execution of the combined job 42. At this time, the job management unit 35 instructs the restart position of the combined job 42 to the execution unit 36. Next, the execution unit 36 resumes the execution of the combined job 42 based on the instruction from the job management unit 35.

When the combined job 42 is being executed by the execution unit 36, the job management unit 35 sequentially updates the combined job information 45 and the job information 46 in accordance with the progress status of the combined job 42. For example, as the execution of the combined job 42 progresses, the job management unit 35 updates the attached information 45b of the combined job information 45 by writing the number of outputted pages and the outputted lengths. Furthermore, as the execution of the combined job 42 proceeds, the job management unit 35 updates the job information 46 by writing the number of outputted pages and the outputted length of each of the jobs A and B therein. The job management unit 35 can manage the progress of each of the plurality of jobs A and B included in the combined job 42 by sequentially updating the job information 46. That is, when the combined job 42 is executed by the execution unit 36, the job management unit 35 can manage the progress of each of the plurality of jobs 41 included in the combined job 42 in real time.

The input/output unit 37 has functions of both an input unit and an output unit. The input/output unit 37 inputs and outputs various data to and from the sheet feed unit 4, the image forming section 13, the sheet ejection unit 6, and the operation panel 19. The input/output unit 37 can also input and output data from and to an external device via the communication interface 33.

The job management unit 35 can output information about a job via the input/output unit 37. If the predetermined condition is satisfied, the job management unit 35 outputs the combined job information 45 and the job information 46 via the input/output unit 37. The predetermined condition includes various conditions. For example, when the combined job 42 is received, the job management unit 35 determines that the predetermined condition is established, and outputs the combined job information 45 and the job information 46. Furthermore, for example, when receiving an output instruction from the user, the job management unit 35 determines that the predetermined condition has been established, and outputs the combined job information 45 and the job information 46. Further, for example, when the execution of the combined job 42 is stopped in the image forming apparatus 8, the job management unit 35 determines that the predetermined condition is satisfied, and outputs the combined job information 45 and the job information 46.

For example, the job management unit 35 generates screen information based on the combined job information 45 and the job information 46, and outputs the screen information to the operation panel 19. Thus, a screen indicating the status of the combined job 42 is displayed on the operation panel 19. The user can grasp the state of the combined job 42 by viewing the screen.

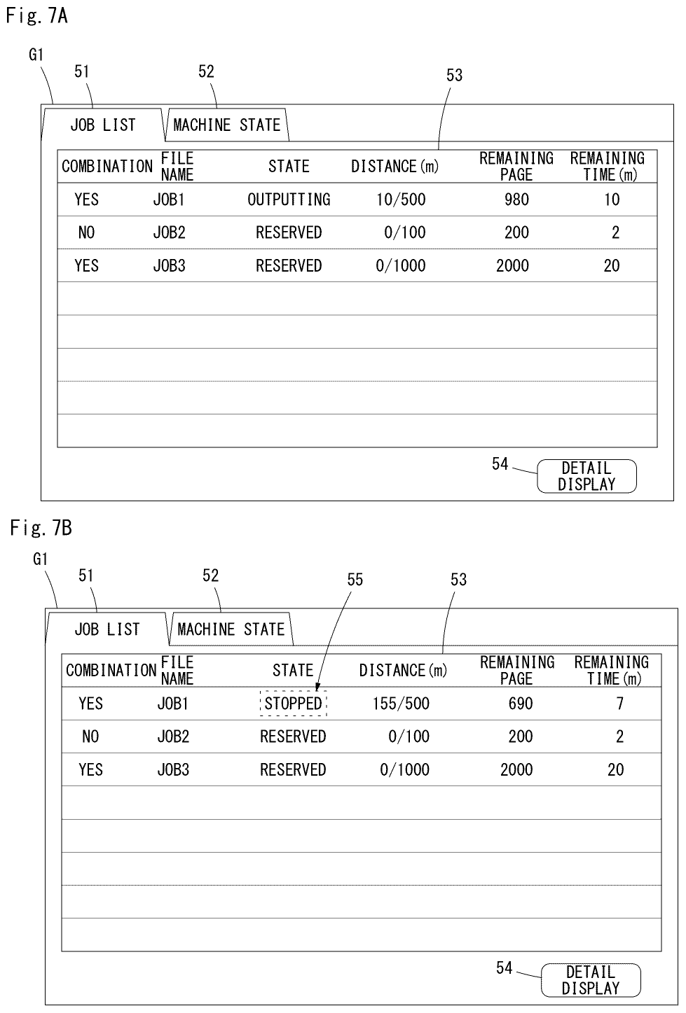

FIG. 7A and FIG. 7B are diagrams exemplifying a screen G1 displayed on the operation panel 19. For example, the job management unit 35 displays a screen G1 as shown in FIG. 7A on the operation panel 19. A screen G1 of FIG. 7A has a screen configuration in which a job list and a machine state can be switched by tabs 51 and 52, and shows a state in which the tab 51 is selected and a job list 53 is displayed. In the job list 53, a plurality of jobs managed by the job management unit 35 are displayed as a list. FIG. 7A shows an example in which three jobs are registered.

In the job list 53, a plurality of items such as presence or absence of combination, a file name, a state, a distance, a remaining page, and a remaining time are displayed for each job. In a case where the job displayed in the job list 53 is the combined job 42, “YES” is displayed in the item of the presence or absence of combination. In the example of FIG. 7A, the first and third jobs are the combined jobs 42 and the second job is a normal job (a single job).

The item of the state indicates the current state of the job. For a job being executed by the image forming apparatus 8, “outputting” is displayed in the item of the status. An unexecuted job registered as a reserved job is displayed as “reserved” in the item of the status. Therefore, the user can ascertain the current status of the job by checking the status item.

The item of distance indicates the distance of the continuous printing medium 9 necessary for execution of the job and the output distance. When a job is being executed, the output distance is sequentially updated by the job management unit 35. Therefore, when the job is executed normally, the output distance displayed in the job list 53 increases in accordance with the progress of the job.

The item of remaining pages indicates and the number of pages that have not been output. For an unexecuted job, the total number of pages included in the job is displayed in the item of remaining pages. When a job is being executed, the number of remaining pages is sequentially updated by the job management unit 35. Therefore, if the job is normally executed, the item of the remaining page decreases in accordance with the progress of the job. When the item of remaining pages becomes 0, it indicates that the execution of the job has been completed.

The item of remaining time indicates the time required for forming the image included in the job on the continuous printing medium 9. Here, the time required for image formation depends on the conveyance speed of the continuous printing medium 9 in the image forming apparatus 8. Therefore, the job management unit 35 calculates the remaining time required for image forming based on the job information including the combined job information 45 and the job information 46 received from the controller 2 and the conveyance speed of the continuous printing medium 9. Next, the job management unit 35 adds the calculated remaining time to the job information. Furthermore, in a case where the controller 2 instructs the image forming apparatus 8 on the conveyance speed of the continuous printing medium 9, when the controller 2 transmits the job information to the image forming apparatus 8, information on the remaining time may be included in the job information in advance.

When a job is being executed, the remaining time is sequentially updated by the job management unit 35. Therefore, if the job is normally executed, the item of the remaining time decreases as the job progresses. When the item of the remaining time becomes 0, it indicates that the execution of the job is completed.

The screen G1 illustrated in FIG. 7A indicates that the combined job 42 with the file name “JOB1”, which is the first in the job list 53, is being executed. Therefore, the screen G1 sequentially updates and displays the items of the distances, the remaining pages, and the remaining times in accordance with the progress of the combined job 42.

When the execution of the combined job 42 with the file name “JOB 1” is stopped halfway by the execution unit 36, the job management unit 35 updates the screen G1 in FIG. 7A to the screen G1 illustrated in FIG. 7B. In the screen G1 shown in FIG. 7B, the display of the item 55 of the state of the combined job 42 having the file name “JOB1” is changed to “stopped”. Therefore, the user knows that an abnormal state has occurred during the execution of the combined job 42 and the job has stopped. Then, the user performs an operation of resolving the abnormal state and sets a state in which the job can be resumed.

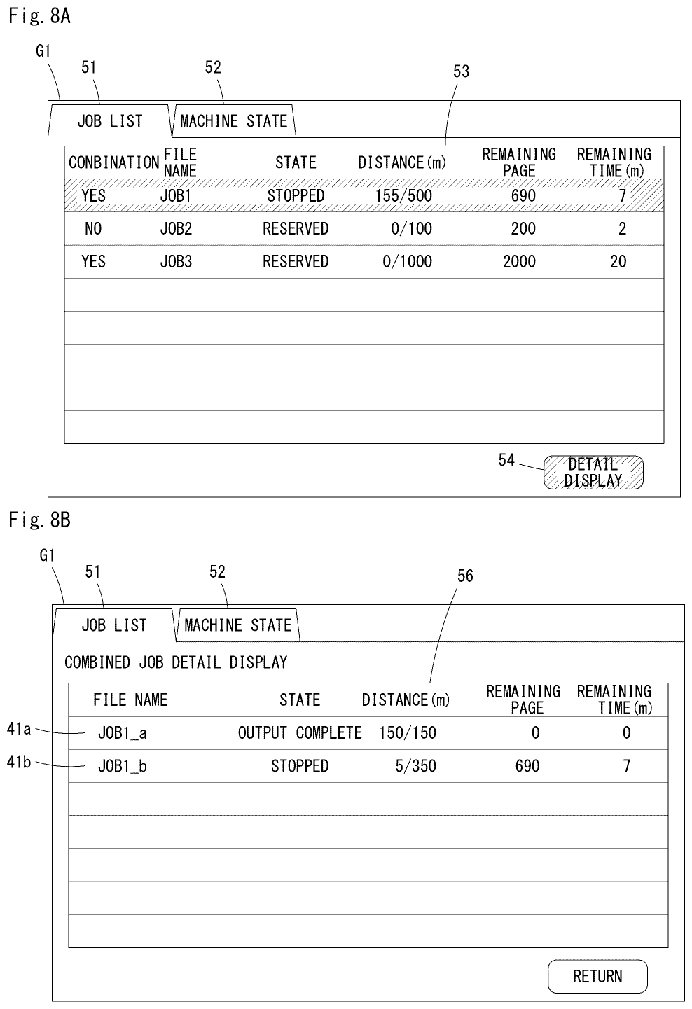

For example, when the user restarts the combined job 42, the user determines a restart position of the combined job 42 and instructs the image forming apparatus 8. At this time, the user can confirm the outputting status of the plurality of jobs 41 included in the combined job 42 by performing an operation on the screen G1. For example, as shown in FIG. 8A, the user selects the combined job 42 with the file name “JOB1” and operates the detail display button 54. Then, the screen G1 displayed on the operation panel 19 changes to the screen G1 illustrated in FIG. 8B. The screen G1 of FIG. 8B displays a detail display field 56 of the combined job 42 in the center thereof. The detail display field 56 displays the progress status of each of the plurality of jobs 41a and 41b included in the combined job 42.

For example, in the example of FIG. 8B, it is displayed that outputting of the first job 41a included in the combined job 42 is already completed, and the job is stopped during outputting of the second job 41b. Such a display allows the user to grasp that the first job 41a does not needs to be reprinted because output thereof has already been completed. Furthermore, the user can know that if the job is resumed from the stopped position, a blank sheet will be mixed in the middle of the second job 41b. Therefore, the user can designate the head position of the second job 41b as a restart position when restarting the combined job 42. By designating the head position of the second job 41b as the restart position, the job management unit 35 determines the position designated by the user as the restart position of the combined job 42. Next, when instructing the execution unit 36 to resume the combined job 42, the job management unit 35 instructs the resumption position. For example, when the top position of the second job 41b is instructed as resumption, the execution unit 36 resumes the image formation from the top page of the second job 41b. Therefore, after the restart of the combined job 42, a blank sheet can be prevented from being mixed in the middle of the second job 41b.

However, in the example of FIG. 8B, since the output of the second job 41b has already been started, when the combined job 42 is restarted from the head position of the second job 41b, the image output before the stoppage is wasted. Therefore, the user can also compare the number of pages that have been output and the number of pages that have not been output, and specify an optimal restart position from the viewpoint of cost and work efficiency.

Further, the job management unit 35 may automatically determine the restart position of the combined job 42. In this case, the job management unit 35 determines the restart position based on the job information 46. For example, when the number of output pages of the second job 41b stopped halfway is equal to or more than half of all the pages, the job management unit 35 determines the position at which the combined job 42 is stopped as the restart position. In this case, although the output pages are not wasted, a blank sheet is mixed in the middle of the second job 41b. When the number of output pages of the second job 41b stopped in the middle is less than half of all pages, the job management unit 35 determines the head position of the second job 41b as the restart position. In this case, although a blank sheet is not mixed in the middle of the second job 41b, pages that have already been output are wasted. Note that the pages serving as the threshold value when the job management unit 35 automatically determines the restart position are not limited to half of all the pages but can be arbitrarily set.

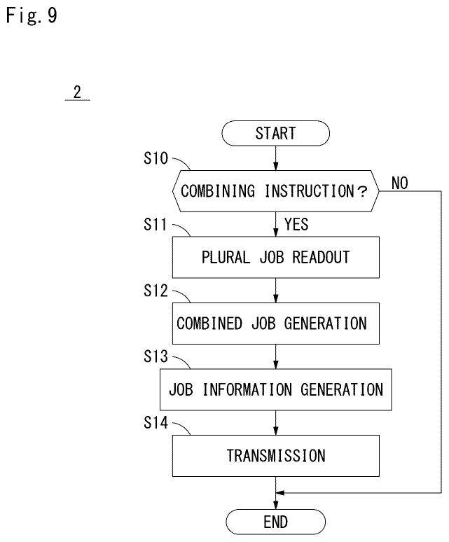

Next, a description is given of processing procedure by the job execution system 1. FIG. 9 is a flowchart illustrating an example of a processing procedure by the controller 2. FIG. 9 illustrates a processing procedure for generating a combined job 42 and transmitting to the image forming apparatus 8. Note that processing based on the flowchart of FIG. 9 is performed by the CPU 20 of the controller 2 executing the program 24.

The controller 2 determines whether a combining instruction to combine a plurality of jobs 41 has been accepted (step S10). If a combining instruction has not been accepted (NO in step S10), the processing by the controller 2 ends. On the other hand, when the combining instruction is received (YES in step S10), the controller 2 reads the plurality of jobs 41 designated as the combining targets (step S11). The controller 2 combines the plurality of read jobs 41 to generate a combined job 42 (step S12). Thus, the combined job information 45 is generated. Next, the controller 2 generates the job information 46 including information relating to at least one of the plurality of jobs 41 included in the combined job 42 (step S13). Then, the controller 2 transmits the combined job 42 to the image forming apparatus 8 (step S14). At this time, the controller 2 transmits the combined job information 45 and the job information 46 to the image forming apparatus 8. Therefore, when the combined job 42 is generated in the controller 2, the combined job information 45 indicating the combined job 42 and the job information 46 related to the job included in the combined job 42 are transmitted from the controller 2 to the image forming apparatus 8.

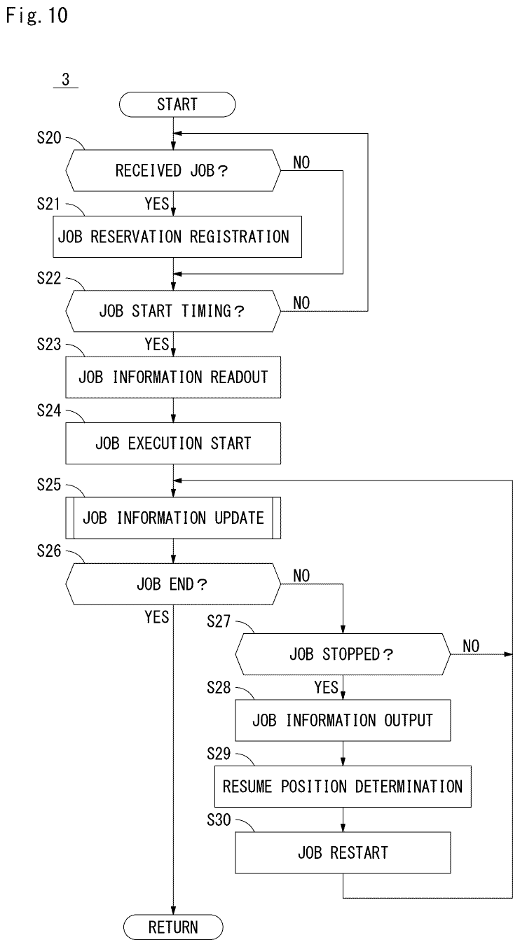

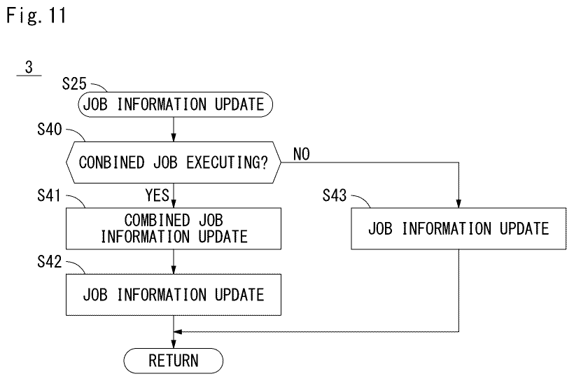

FIGS. 10 and 11 are flowcharts showing an example of a processing procedure by the image forming apparatus 8. The processing based on FIGS. 10 and 11 is performed by the CPU 31 of the image forming apparatus 8 executing the program 34.

The image forming apparatus 8 determines whether a job has been received from the controller 2 (step S20). If a job has been received (YES in step S20), the image forming apparatus 8 registers the received job as a reserved job (step S21). For example, when the combined job 42 is received, the image forming apparatus 8 registers the combined job 42 based on the combined job information 45 and the job information 46 as a reserved job. At this time, the combined job 42 is a job obtained by combining the two jobs A and B, and the job information 46 may include information on only one of the jobs A and B. In that case, the image forming apparatus 8 estimates information about the other job based on the attached information 45b and the job information 46 included in the combined job information 45, and additionally registers the information in the job information 46.

Next, the image forming apparatus 8 determines whether it is time to start a new job (step S22). If it is the start timing of a new job (YES in step S22), the image forming apparatus 8 reads job information to be executed next (step S23). If the job to be executed next is the combined job 42, the image forming apparatus 8 reads out the combined job information 45 and the job information 46 corresponding to the combined job 42. Then, the image forming apparatus 8 starts execution of the job (step S24). Thus, images included in the job are sequentially formed on the continuous printing medium 9. When starting the execution of the job, the image forming apparatus 8 updates the job information with the progress of the job (step S25).

FIG. 11 is a flowchart illustrating an example of a detailed processing procedure of job information update (step S25). When the job information is updated, the image forming apparatus 8 determines whether the combined job 42 is being executed (step S40). If the combined job 42 is being executed (YES in step S40), the image forming apparatus 8 updates the combined job information 45 in accordance with the progress of the combined job 42 (step S41). That is, the image forming apparatus 8 writes the progress status of the current combined job 42 in the attached information 45b of the combined job information 45, and updates the attached information 45b. Therefore, the progress status of the entire combined job 42 is recorded in the attached information 45b of the combined job information 45. However, the progress status of each job included in the combined job 42 is not recorded in the attached information 45b of the combined job information 45. Then, the image forming apparatus 8 updates the job information 46 after updating the attached information 45b of the combined job information 45 (step S42). That is, the image forming apparatus 8 writes the progress status of each of the jobs A and B included in the combined job information 45 into the information 46a and 46b related to each of the jobs A and B to update the job information 46. Thus, as the combined job 42 progresses, the progress status of each of the jobs A and B included in the combined job 42 is recorded in the job information 46.

On the other hand, if not the combined job 42 but a normal job is being executed (NO in step S40), the image forming apparatus 8 writes and updates the progress status of the normal job in the job information of the normal job (step S43). Thus, the processing of the job information update (step S25) ends.

Return to the flowchart of FIG. 10. Next, the image forming apparatus 8 determines whether or not the job being executed has ended (step S26). If the job is not completed (NO in step S26), the image forming apparatus 8 determines whether the job is stopped halfway due to jam, toner empty, or the like (step S27). If the job has not been stopped (NO in step S27), the process by the image forming apparatus 8 returns to step S25, and a process of updating the job information in accordance with the progress of the job is performed.

On the other hand, when the job is stopped halfway (YES in step S27), the image forming apparatus 8 outputs job information. If the stopped job is the combined job 42, the image forming apparatus 8 generates and outputs information allowing confirmation of the stop position of the combined job 42 based on the combined job information 45 and the job information 46 at the time of the stop. For example, the image forming apparatus 8 generates screen information that can be displayed on the display part 19a of the operation panel 19, and outputs the screen information to the operation panel 19. Thus, for example, a screen G1 illustrated in FIG. 8B is displayed on the operation panel 19. Therefore, when the combined job 42 is stopped in the middle, the user can grasp how far the output of the plurality of jobs 41 included in the combined job 42 has been completed. Note that the image forming apparatus 8 may output job information to an external device via the communication interface 33.

When the abnormal condition in which the job is stopped is solved, the image forming apparatus 8 determines the restart position of the job (step S29). For example, the image forming apparatus 8 determines a position specified by the user as the restart position. Furthermore, the image forming apparatus 8 may automatically determine the job resumption position. Since the image forming apparatus 8 holds the job information 46 related to the plurality of jobs 41 included in the combined job 42, for example, the head position of a specific job among the plurality of jobs 41 may be automatically determined as the restart position. Then, the image forming apparatus 8 restarts the execution of the job from the determined restart position (step S30). Thereafter, the process by the image forming apparatus 8 returns to step S25, and a process of updating the job information in accordance with the progress of the job is performed.

When the job ends normally without stopping (YES in step S26), the processing by the image forming apparatus 8 returns to step S20, and the above-described processing is repeatedly executed.

As described above, the job execution system 1 of the present embodiment includes the controller 2 and the image forming apparatus 8, and the controller 2 generates a job and transmits it to the image forming apparatus 8. The controller 2 can generate a combined job 42 by combining a plurality of jobs 41. When the combined job 42 is generated, the controller 2 generates job information 46 related to at least one job of the plurality of jobs 41 included in the combined job 42. Then, the controller 2 transmits the combined job information 45 related to the combined job 42 and the job information 46 to the image forming apparatus 8. On the other hand, upon acquiring the combined job information 45 and the job information 46 from the controller 2, the image forming apparatus 8 manages the combined job 42 based on the combined job information 45 and the job information 46. Then, the image forming apparatus 8 executes the combined job 42.

The job execution system 1 having such a configuration can manage the progress status of each of the plurality of jobs 41 included in the combined job 42 in the image forming apparatus 8. Therefore, When the image forming apparatus 8 stops the execution of the combined job 42 halfway, the stop position can specify the stopped job from among the plurality of jobs 41. Furthermore, the image forming apparatus 8 can also identify the stop position of the identified job. Therefore, when resuming the execution of the combined job 42, the image forming apparatus 8 can set the start position of any one of the plurality of jobs 41 as the resumption position. Thus, mixing of a blank sheet in the middle of each of the jobs included in the combined job 42 can be suppressed. Furthermore, it is also possible to improve work efficiency in a later cutting process.

### MODIFICATION EXAMPLE

A preferred embodiment of the present invention has been described above. However, the present invention is not limited to the content described in the above embodiment, and various modification examples are applicable.

For example, in the above-described embodiment, the case where the job execution apparatus 3 is the image forming apparatus 8 is exemplified. However, the job execution apparatus 3 is not necessarily limited to the image forming apparatus 8 that forms an image on the continuous printing medium 9. For example, the job execution apparatus 3 may be an apparatus that transmits a job included in the combined job 42 to the outside by executing the combined job 42. Furthermore, the job execution apparatus 3 may be a raster image processor that rasterizes image data included in the combined job information 45 to generate a raster image by executing the combined job 42.

Furthermore, for example, in the embodiment described above, the controller 2 transmits the combined job information 45 and the job information 46 to the image forming apparatus 8, which is mainly effective in determining the restart position of the combined job 42 stopped in the image forming apparatus 8. However, when the controller 2 transmits the combined job information 45 and the job information 46 to the image forming apparatus 8, useful effects other than those described above can be achieved. For example, the image forming apparatus 8 can manage each of the plurality of jobs 41 included in the combined job 42 by managing the combined job 42 based on the combined job information 45 and the job information 46. Therefore, after registering the combined job 42 as a reserved job, the image forming apparatus 8 in can individually cancel each of the plurality of jobs 41 included in the combined job 42. For example, the image forming apparatus 8 has an advantage that even after starting execution of the combined job 42, the job can be cancelled if the job specified as a job to be cancelled has not been executed.

Further, for example, in the above-described embodiment, an example has been described in which the image forming apparatus 8 manages the combined job 42 by using all information included in the job information 46 received from the controller 2. However, the image forming apparatus 8 may not use all the information included in the job information 46 when managing the combined job 42. For example, in a case where the combined job 42 includes two jobs A and B, the image forming apparatus 8 can appropriately manage the progress status of the combined job 42 with either one of the information 46a on the job A and the information 46b on the job B. Therefore, the image forming apparatus 8 may manage the combined job 42 by using at least one of the information 46a about the job A and the information 46b about the job B. For example, when the image forming apparatus 8 receives the job information 46 of the combined job 42 in which the two jobs A and B are combined, the image forming apparatus 8 may acquire and use only the information 46a of the job A and may not use the information 46b of the job B.

In addition, for example, in the above-described embodiment, a case where the continuous printing medium 9 is the roll sheet 10 is exemplified, but the continuous printing medium 9 is not limited to the roll sheet 10. For example, the continuous printing medium 9 may be a continuous form.

Furthermore, for example, the above embodiment illustrates the case where the programs 24 and 34 to be executed in the controller 2 and the image forming apparatus 8, respectively, are stored in the storage sections 21 and 32 in advance. However, the programs 24 and 34 are not limited to those stored in the storage sections 21 and 32 in advance. That is, the program 24, 34 can be a target of transaction by itself. Therefore, the programs 24 and 34 may be provided in a state of being recorded on a computer-readable non-transitory recording medium, or may be provided in a mode of being downloadable via a network such as the Internet.

Although embodiments of the present invention have been described and illustrated in detail, the disclosed embodiments are made for purposes of illustration and example only and not limitation. The scope of the present invention should be interpreted by terms of the appended claims.

What is claimed is:

1. A job execution system comprising a controller and a job execution apparatus, wherein
the controller combines a plurality of jobs to generate a combined job, and transmits job information on at least one of the plurality of jobs and the combined job, and
the job execution apparatus acquires and manages the job information and the combined job, and executes the combined job.

2. The job execution system according to claim 1, wherein
the job information includes information relating to the plurality of jobs.

3. The job execution system according to claim 2, wherein
the job execution apparatus manages the combined job based on information relating to at least one job included in the information relating to the plurality of jobs.

4. The job execution system according to claim 1, wherein
the job execution apparatus outputs the job information when a predetermined condition is satisfied.

5. The job execution system according to claim 4, wherein
the job execution apparatus includes an image forming section that forms an image on a continuous printing medium based on the combined job, and
when the combined job is stopped during image forming by the image forming section, the job execution apparatus outputs the job information.

6. The job execution system according to claim 5, wherein
the job execution apparatus causes the image forming section to resume image forming based on the job information.

7. The job execution system according to claim 5, wherein
the job execution apparatus determines a restart position of the stopped combined job, and restarts the combined job from the determined restart position.

8. The job execution system according to claim 7, wherein
the job execution apparatus determines the restart position based on the job information.

9. The job execution system according to claim 4, wherein
the job execution apparatus includes an image forming section that forms an image on a continuous printing medium based on the combined job, and
the job execution apparatus updates the job information in accordance with progress of the combined job by the image forming section, and outputs the updated job information.

10. The job execution system according to claim 9, wherein
the job execution apparatus updates information, included in the job information, on a distance of the continuous printing medium required for image forming.

11. The job execution system according to claim 9, wherein
the job execution apparatus updates information, included in the job information, related to time required for image forming.

12. The job execution system according to claim 9, wherein
the job execution apparatus stops the combined job in the middle of image forming by the image forming section, and outputs the job information at a time point when the combined job is stopped.

13. A control method for controlling an image forming apparatus, the control method comprising:
acquiring a combined job in which a plurality of jobs combined and job information relating to at least one of the plurality of jobs;
forming an image based on the combined job;
updating the job information in accordance with progress of the combined job; and
outputting the job information.

14. The control method according to claim 13, wherein
the job information includes information relating to the plurality of jobs.

15. The control method according to claim 13, wherein
the control method includes forming the image on a continuous printing medium, and outputting the job information in a case where the combined job is stopped while the image is being formed on the continuous printing medium.

16. A non-transitory computer-readable recording medium storing a program to be executed by a hardware processor of an image forming apparatus, the program causing the hardware processor to perform:
acquiring a combined job in which a plurality of jobs combined and job information relating to at least one of the plurality of jobs;
forming an image based on the combined job;
updating the job information in accordance with progress of the combined job; and
outputting the job information.

17. The non-transitory computer-readable recording medium according to claim 16, wherein
the job information includes information relating to the plurality of jobs.

18. The non-transitory computer-readable recording medium according to claim 16, wherein
the program causes the hardware processor to perform:
forming the image on a continuous printing medium; and
outputting the job information in a case where the combined job is stopped while the image is being formed on the continuous printing medium.
